(19) United States
(12) Patent Application Publication
(10) Pub. No.: US 2025/0278633 A1
(43) Pub. Date: Sep. 4, 2025

(54) PROMPT DESIGN ITERATION INTERFACE FOR LARGE LANGUAGE MODELS

(71) Applicant: Intuit Inc., Mountain View, CA (US)

(72) Inventors: Samuel Austin SMITH, Trophy Club, TX (US); Vivek SRINIVASAN, Manhattan Beach, CA (US)

(73) Assignee: Intuit Inc., Mountain View, CA (US)

(21) Appl. No.: 18/592,514

(22) Filed: Feb. 29, 2024

(51) Int. Cl. G06N 3/091

(52) U.S. Cl. CPC G06N 3/091

(57) ABSTRACT

Systems and methods are disclosed for aiding the design and iteration of prompts submitted to a text-to-text language model (language model). An example method includes obtaining a first prompt from a user, obtaining a first response to the first prompt, the first response generated by the language model, transmitting a second prompt from the user to the language model via an electronic communication interface, receiving, via the electronic communication interface, a second response to the second prompt from the language model, comparing the first prompt to the second prompt, comparing the first response to the second response, providing, on a display coupled to the computing device, a first prompt change record representing changes between the first prompt and the second prompt, and providing, on the display. a first response change record representing changes between the first response and the second response.

### TECHNICAL FIELD

This disclosure relates generally to generative artificial intelligence (AI) models, such as large language models (LLMs), and more specifically to the design and iteration of prompts for submission to such generative AI models.

### DESCRIPTION OF RELATED ART

A generative artificial intelligence (AI) model is a model that is trained to generate content based on prompts to the model. Generative AI models operating on text prompts and generating text content based on such prompts may be referred to as large language models, or LLMs. One popular LLM is ChatGPT® from OpenAIR. The ChatGPT model receives a user input requesting a text output from the model, and the ChatGPT model generates and outputs text based on the user input. While ChatGPT is one example LLM, various other LLMs exist and are in development, such as InstructGPT, GPT-4, Google® Bard, and so on. Such LLMs may be referred to as a question and answer model, where the model is provided a natural language question or “prompt” and the model generates a natural language answer to the question.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for the design and iteration of prompts submitted to a text-to-text language model (language model). An example method may be performed by a computing device coupled to the language model and include obtaining a first prompt from a user, obtaining a first response to the first prompt, the first response generated by the language model, transmitting a second prompt from the user to the language model via an electronic communication interface, receiving, via the electronic communication interface, a second response to the second prompt from the language model, comparing the first prompt to the second prompt, comparing the first response to the second response, providing, on a display coupled to the computing device, a first prompt change record representing changes between the first prompt and the second prompt, and providing, on the display, a first response change record representing changes between the first response and the second response.

In some aspects, the first prompt change record displays additions to the second prompt not present in the first prompt, and displays portions of the first prompt which are not present in the in the second prompt. In some aspects, the additions to the second prompt not present in the first prompt are depicted underlined, and the portions of the first prompt not present in the second prompt are depicted struck through. In some aspects, the additions to the second prompt are depicted in a first color, and the portions of the first prompt not present in the second prompt are depicted in a second color different from the first color.

In some aspects, the method further includes, after receiving the second response, transmitting a third prompt to the language model via the electronic communication interface, receiving a third response to the third prompt from the language model via the electronic communication interface, comparing the third prompt to the second prompt, comparing the third response to the second response, providing, on the display, a second prompt change record representing changes between the second prompt and the third prompt, and providing, on the display, a second response change record representing changes between the second response and the third response.

In some aspects, the method further includes receiving a request from the user to save the second prompt and the second response for comparison with subsequently received prompts and subsequently generated responses, and in response to receiving the request, storing the second prompt and the second response in a memory coupled to the computing device.

In some aspects, transmitting the second prompt includes indicating one or more first contexts associated with the second prompt, wherein the second response is generated based at least in part on the one or more first contexts. In some aspects the one or more first contexts indicate at least a region associated with the second prompt. In some aspects the one or more first contexts indicate at least a voice or a tone desired for the second response.

In some aspects, obtaining the first prompt includes receiving the first prompt from the user, and obtaining the first response includes transmitting the first prompt to the language model via the electronic communication interface and receiving the first response via the electronic communication interface.

In some aspects, obtaining the first prompt includes receiving a selection of the first prompt from the user via an interface presented on the display, and retrieving the first prompt from a memory coupled to the computing device, and obtaining the first response includes retrieving the first response from the memory. In some aspects, the interface presented on the display comprises a plurality of selectable prompts, wherein each selectable prompt of the plurality of selectable prompts includes a previously submitted prompt associated with a corresponding response previously generated by the language model.

In some aspects, the method further includes, before transmitting the second prompt, providing the first prompt and the first response on the display.

Another innovative aspect of the subject matter described in this disclosure can be implemented as a system for the design and iteration of prompts submitted to a text-to-text language model (language model). An example system includes one or more processors, and a memory storing instructions for execution by the one or more processors. Execution of the instructions causes the system to perform operations including obtaining a first prompt from a user, obtaining a first response to the first prompt, the first response generated by the language model, transmitting a second prompt from the user to the language model via an electronic communication interface, receiving, via the electronic communication interface, a second response to the second prompt from the language model, comparing the first prompt to the second prompt, comparing the first response to the second response, providing, on a display coupled to the computing device, a first prompt change record representing changes between the first prompt and the second prompt, and providing, on the display, a first response change record representing changes between the first response and the second response.

Another innovative aspect of the subject matter described in this disclosure can be implemented as a computer-implemented method for the design and iteration of prompts submitted to a text-to-text language model (language model). An example method may be performed by a computing device coupled to the language model and include obtaining a first prompt, obtaining a first response to the first prompt, the first response generated using the language model, receiving a second prompt from a remote computing device via an electronic communication interface, generating second response to the second prompt using the language model, comparing the first prompt to the second prompt, comparing the first response to the second response, transmitting, to the remote computing device via the electronic communication interface, a first prompt change record representing changes between the first prompt and the second prompt, and transmitting, to the remote computing device via the electronic communication interface, a first response change record representing changes between the first response and the second response.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system for prompt design iteration, according to some implementations.

FIG. 2 shows a high-level overview of an example process flow that may be employed by the system of FIG. 1.

FIG. 3 shows an example user interface for aiding users with prompt design, in accordance with some implementations.

FIG. 4 shows an illustrative flow chart depicting an example operation for the design and iteration of prompts submitted to a text-to-text language model (language model), according to some implementations.

FIG. 5 shows an illustrative flow chart depicting an example operation for the design and iteration of prompts submitted to a text-to-text language model (language model), according to some implementations.

Like numbers reference like elements throughout the drawings and specification.

### DETAILED DESCRIPTION

Implementations of the subject matter described in this disclosure may be used to provide users of text-to-text language models (language models) or generative AI models with interactive feedback to improve prompt design through iteration. The generative AI models and language models referred to herein are configured to generate a natural language answer to a question provided to the model. Such text-to-text language models may be referred to as large language models, or LLMs.

Prompt design is important when generating natural language text or other responses using a language model. For example, a language model may respond to a user's poorly designed prompt with an unhelpful response, such as a response which technically addresses the prompt, but does not directly address the user's needs. Further, depending on the prompt submitted, a language model may be more or less subject to hallucinations. Hallucinations in the context of language model models refers to the generations of incorrect responses to prompts. Users may not be experienced or knowledgeable enough to design high quality prompts without assistance. Accordingly, it would be desirable to provide users with assistance with prompt design to improve the quality of responses generated by those users' prompts to a language model.

Various implementations of the subject matter disclosed herein provide one or more technical solutions to the problem of assisting users in designing effective prompts for submission to language models. In some aspects, the example implementations may provide users with a prompt design iteration interface presenting a visual representation of how changes in prompts lead to changes in responses generated by a language model. For example, a user may submit a first prompt to and receive a first response from a language model. The user may then submit additional prompts to and receive additional responses from the language model. In some aspects the prompt design iteration interface may display changes between submitted prompts and between received answers, such as presenting differences between a most recently submitted prompt and a second most recently submitted prompt, and between a most recently received answer and a second most recently received answer. Such an interface may allow users to intuitively identify how changes in prompts lead to changes in responses, and more particularly which alterations to prompts lead to accurate or helpful changes in responses from the language model. Such changes may be presented in the prompt design iteration interface such that additions and deletions to prompts and answers are presented in distinctive colors or with distinctive formatting, such as using underlines, strike-through formatting, and similar. Further, in some aspects, a user may select two prompts from a plurality of different prompts and cause the interface to display differences between the selected prompts and between the corresponding answers to the selected prompts. These and further aspects of the example implementations are discussed in more detail below.

Various aspects of the present disclosure provide a unique computing solution to a unique computing problem that did not exist prior to the creation of machine learning models, and in particular language models. The techniques for providing intuitive visual feedback to assist users in drafting effective prompts for submission to language models as described herein cannot be performed in the human mind, much less practically in the human mind, including the use of pen and paper. As such, implementations of the subject matter disclosed herein are not an abstract idea such as organizing human activity or a mental process that can be performed in the human mind.

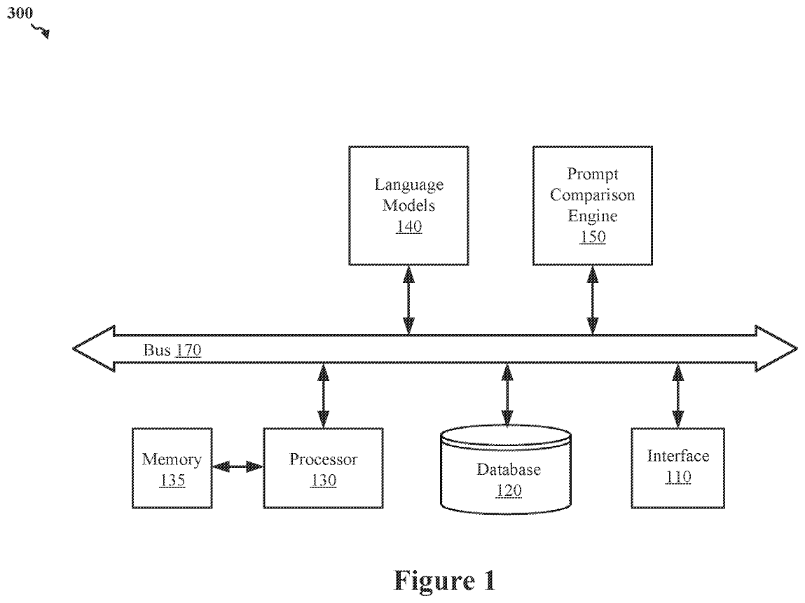

FIG. 1 shows an example system 100 for prompt design iteration, according to some implementations. The system 100 includes an interface 110, a database 120, a processor 130, a memory 135 coupled to the processor 130, one or more language models 140, and a prompt comparison engine 150. In some implementations, the language models 140 may not be included in the system 100 but may instead be coupled to the system 100, such as via a data bus 170, via a network interface, or similar. In some implementations, the various components of the system 100 may be interconnected by at least the data bus 170, as depicted in the example of Figure!. In other implementations, the various components of the system 100 may be interconnected using other suitable signal routing resources.

The interface 110 may be one or more input/output (I/O) interfaces to obtain inputs to one or more language models, provide or obtain outputs from one or more language models, or receive or provide inputs or outputs for continued operation of the system 100. An example interface may include a wired interface or wireless interface to the internet or other means to communicably couple with other devices. In some implementations, the interface 110 may include an interface with an ethernet cable or a wireless interface to a modem, which is used to communicate with an internet service provider (ISP) directing traffic to and from other devices (such as a system used by a developer, tester, or other types of users to use the system 100 for a language model 140). If the system 100 is local to a user (such as to an internal developer), the interface 110 may include a display, a speaker, a mouse, a keyboard, or other suitable input or output elements that allow interfacing with the user (such as to provide a prompt to the language models 140, receive prompts and configuration commands from the user, provide outputs from the language models 140, receive feedback from the user, and so on).

The database 120 may store prompts submitted to the language models 140, responses generated by the language models 140, configuration options associated with the system 100, configuration options associated with prompts submitted to the language models 140, such as desired voice or tone associated with responses generated by the language models 140, or other computer executable instructions or data for operation of the system 100. In some implementations, the database 120 may include a relational database capable of presenting information as data sets in tabular form and capable of manipulating the data sets using relational operators. For example, the database 120 may store prompt-response pairs, including a prompt submitted to the language models 140 and an associated response to the prompt generated by the language models 140. The database 120 may use Structured Query Language (SQL) for querying and maintaining the database 120.

The processor 130 may include one or more suitable processors capable of executing scripts or instructions of one or more software programs stored in system 100 (such as within the memory 135). For example, the processor 130 may be capable of executing one or more applications, any of the one or more language models 140, or the prompt comparison engine 150. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. For example, the memory 135 may store the one or more applications, any of the language models 140, or the prompt comparison engine 150 that may be executed by the processor 130. The memory 135 may also store inputs, outputs, or other information associated with the components 140 or 150 of the system 100 or any other data for operation of the system 100.

The language models 140 include one or more large language models (LLMs) to be used for generating responses to prompts and in connection with the prompt iteration interface provided by the system 100. In some implementations, the language models 140 include one or more pretrained LLMs for use by the system 100.

The prompt comparison engine 150 is configured to compare selected prompts submitted to the language models 140 and to compare corresponding responses generated by the language models 140 to provide users with a visual representation of how changes in prompt design correspond to changes in responses generated by the language models 140.

While the language models 140 and the prompt comparison engine 150 are depicted as separate components of the system 100 in FIG. 1 for clarity, the components 140 and 150 may be included in software including instructions stored in memory 135 or the database 120. In addition, components of the system 100 may be included in one device, distributed across multiple devices, may be included in fewer components, and so on. If the components are software, the components may be implemented using any suitable computer-readable language. For example, one or more of the language models 140 or the prompt comparison engine 150 or the configuration and interoperability of such components, may be programmed in the Python programming language using any suitable libraries.

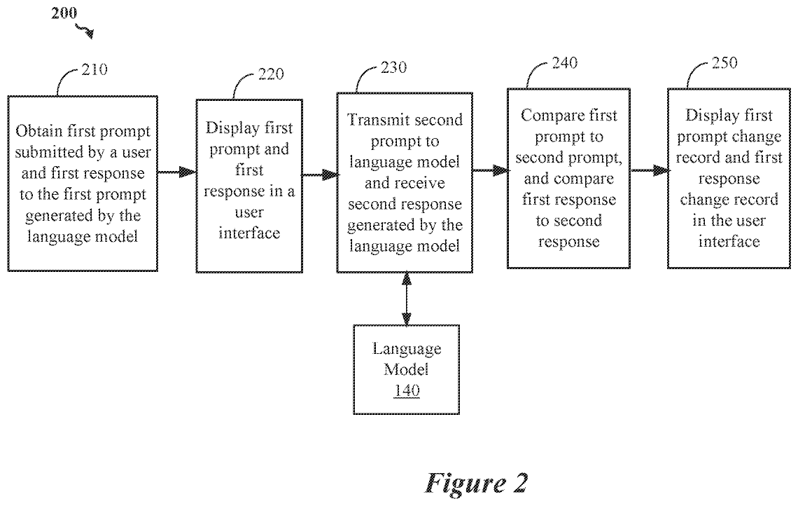

FIG. 2 shows a high-level overview of an example process flow 200 that may be employed by the system 100 of FIG. 1. In block 210, the system 100 obtains a first prompt submitted by a user, and a first response to the first prompt generated by a language model. For example, the first prompt may be received from a user via the interface 110, such as via a keyboard or other input device coupled to the interface 110, or be retrieved from a memory, such as the database 120 or another memory contained within or coupled to the system 100. The first prompt may also be received via an electronic communication interface included within or coupled to the system 100, such as via the bus 170, the interface 110, or a network interface coupled to the system 100. Similarly, the first response may be retrieved from a memory such as the database 120 or another memory contained within or coupled to the system 100, via an electronic communication interface coupled to the system 100, or the first response may be generated by a language model such one of the language models 140 of the system 100. In block 220, the system 100 may display the first prompt and the first response in a user interface. For example, the first prompt and the first response may be displayed in a user interface of a display coupled to the system 100 via the interface 110. In block 230, system 100 may transmit a second prompt to the language model and receive a second response to the second prompt generated by the language model. For example, the second prompt may be received from the user via the interface 110, such as via a keyboard or another input device coupled to the interface 110, via the electronic communication interface, such as the bus 170, the interface 110, or via a network interface coupled to the system 100. In block 240, the system 100 may compare the first prompt to the second prompt and compare the first response to the second response. For example, the comparison may be performed by the prompt comparison engine 150 of the system 100. In block 240, the system 100 may display a first prompt change record and a first response change record in the user interface. For example, the first prompt change record and the first response change record may be generated by the prompt comparison engine 150 of the system 100. The first prompt change record indicates changes between the first prompt and the second prompt, and the first response change record indicates changes between the first response and the second.

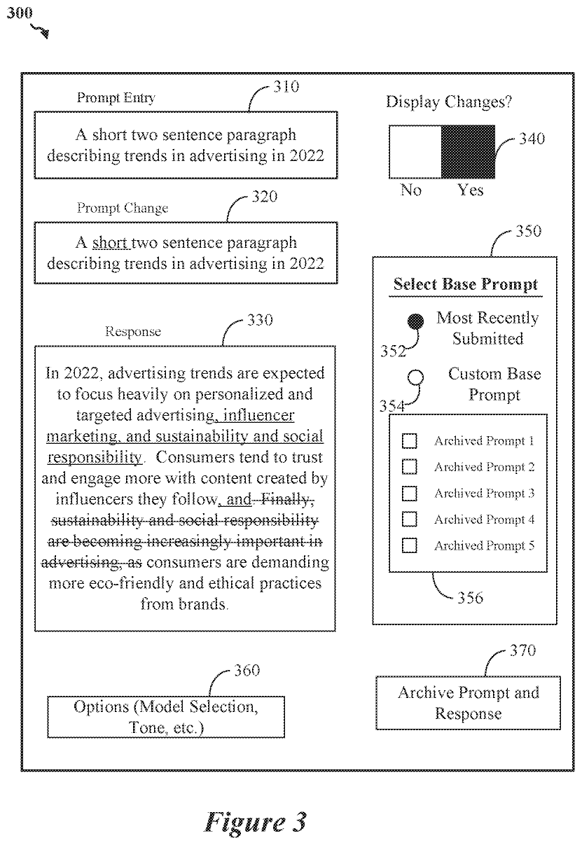

As discussed above, the example implementations provide an interface to aid users in designing prompts for submission to a language model by providing feedback to the user displaying how changes in prompt design change the responses generated by the language model to those prompts. FIG. 3 shows an example user interface 300 for aiding users with prompt design, in accordance with some implementations. The user interface 300 is shown to include a prompt entry region 310, a prompt change region 320, a response region 330, a change depiction toggle 340, a base prompt selection region 350, an options button 360, and a prompt/response archive button 370. In the prompt entry region 310, a user may input a prompt for submission to a language model, such as one of the language models 140 of FIG. 1. Such a prompt entered in the prompt entry region 310 may be referred to as a “current prompt,” The user interface 300 is also shown to include a prompt change region 320 to display differences between the current prompt and a selected base prompt based on a comparison of the current prompt and the selected base prompt. The base prompt may be a most previously entered prompt prior to entry of the current prompt, or may be another previously entered prompt, such as an archived prompt or another prompt stored in a memory coupled to the user interface 300, such as the database 120 or another memory coupled to the system 100. For example, differences between the selected base prompt and the current prompt may be shown by underlining additions to the current prompt not found in the selected base prompt, and striking through portions of the selected base prompt which are not found in the current prompt. Alternatively or in addition, such additions and deletions may be depicted using distinct colors of font, background, other font formatting (e.g., bold or italic), or using any suitable distinguishing criteria.

The user interface 300 is also shown to include a response region 330. The response region 330 may depict responses to the current prompt generated by the language model, or may depict changes between the response to the current prompt and a corresponding response to the selected base prompt. The responses to the selected base prompt may be stored in a memory coupled to the user interface 300, such as the database 120 or another memory coupled to the system 100.

The change depiction toggle 340 may allow a user to select whether or not changes are depicted in the user interface 300 between the current prompt and the selected base prompt, and the respective responses generated by the language model. In some aspects, the change depiction toggle may be omitted from the user interface 300 or may be found instead in options displayed in response to selection of the options button 360. When the change depiction toggle 340 is selected to display changes, then changes between the current prompt and the selected base prompt are displayed in the prompt change region 320, and changes between the response to the current prompt and the response to the selected base prompt are depicted in the response region 330. When the change depiction toggle 340 is selected not to display changes, then these changes may not be shown. For example, the prompt change region 320 may be empty, or may instead show only the current prompt, and the response region 330 may depict only the response to the current prompt.

The base prompt selection region 350 may allow a user to select the base prompt and corresponding base response to which the current prompt and the response to the current prompt will be compared. For example, a user may select the “most recently submitted” option 352 to select the most recently submitted prompt as the base prompt (and the response to the most recently submitted prompt as the base response), or may select a custom base prompt, for example by selecting the custom base prompt option 354 and then selecting an archived prompt from among the archived prompts 356. The custom base prompt may be any previously submitted prompt which has been stored or archived in a memory coupled to the user interface 300, such as in the database 120 or another memory coupled to the system 100. Selecting a base prompt from among the archived prompts also selects the respective response to the archived prompt as the base response. Note that while only five archived prompts are depicted in FIG. 3, that any number of archived prompts may be available for selection as the base prompt, and that the base prompt selection region 350 may include a scrollable window for scrolling between the archived prompts, or may include any other suitable technique for viewing the available archived prompts and selecting the base prompt from among those available archived prompts.

The user interface 300 may also include an options button 360 for selection of options relating to the generation of responses using the language model. For example, such options may include selection of one or more contexts for responses to be generated by the language model. Such contexts may include a tone, such as an emotional or professional tone, or an institutional tone associated with a company or other entity associated with the user interface 300. The contexts may also include a region associated with responses to be generated using the language models. For example, if a user selects the United States as the region, then currency values may be expressed in US Dollars in generated responses, whereas if the user selects the European Union, then such currency amounts may be expressed in Euros in generated responses. Such contexts may also include a style or format which all generated responses are to conform to, such as formatting associated with a software environment in which a generated response is to be deployed. For example, such a context may stipulate that all responses should include software instructions tied to the software environment, one or more application programming interface (API) keys associated with the software environment, and so on. Further, the options associated with the options button 360 may include a selection of the language model for generating responses to the prompts. For example, the language models 140 of the system 100 may include multiple language models, and the options may allow selection of one of the multiple models.

The user interface 300 may enable the user to archive the current prompt and its corresponding response in response to selecting the archive prompt and response button 370. For example, the archived current prompt and response may be added to the list of archived prompts 356 in the base prompt selection region, so that the user may later select the archived current prompt as the base prompt, and the corresponding response to the archived current prompt as the base response.

The user interface 300 is shown as depicting changes between a most recently submitted base prompt and a current prompt. For example, the base prompt selection region shows that the “most recently submitted” option is selected, indicating that the most recently submitted prompt should be used as the base prompt. Further, the change depiction toggle is selected to display changes between the current prompt and the selected base prompt (the most recently submitted prompt). The prompt entry region 310 includes the current prompt “A short two sentence paragraph describing trends in advertising in 2022.” The user may enter this prompt in the prompt entry region 310 and hit “enter” or select a submit button to send the current prompt to the language model for generating a response (submit button not shown in FIG. 3 for simplicity. This current prompt may be compared to the selected base prompt, and the prompt change region 320 indicates the changes based on such a comparison, and shows that the word “short” was added, but that no other changes were made to the most recently submitted prompt. A response is received from the language model and compared to a stored response to the selected based prompt. The response region 330 displays the differences between the most recently submitted prompt and the stored response to the base prompt based on this comparison, indicating additions using underlining, and deletions using strike through. Thus, a user may immediately see how the changes made to the current prompt, as compared with the base prompt, lead to changes in the response generated by the language model.

In some aspects, the user interface 300 may be presented to the user on a display of the system 100, while in some other aspects, the user interface 300 may be presented to the user on a display of a computing device different to and remote from the system 100.

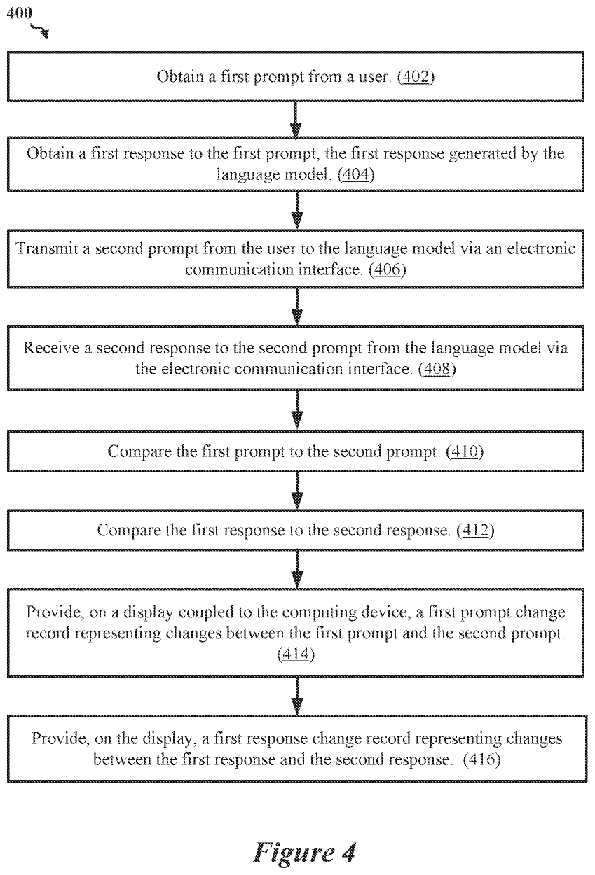

FIG. 4 shows an illustrative flow chart depicting an example operation 400 for the design and iteration of prompts submitted to a text-to-text language model (language model), according to some implementations. The example operation 400 is described as being performed by the system 100 depicted in FIG. 1 with reference to the user interface 300 in FIG. 3 for clarity only, and the operation 400 may be performed by any suitable device or system including or coupled to at least one language model.

At block 402, the system 100 obtains a first prompt from a user. In some aspects, a means for receiving the first prompt may include the interface 110, the processor 130 executing instructions stored in the memory 135, the database 120, the bus 170, or the prompt comparison engine 150 of the system 100, or the base prompt selection region 350 or prompt entry region 310 of the user interface 300.

At block 404, the system 100 obtains a first response to the first prompt, where the first response is generated by the language model. In some aspects, a means for obtaining the first response may include the interface 110, the processor 130 executing instructions stored in the memory 135, the database 120, the bus 170, the language models 140, or the prompt comparison engine 150 of the system 100, or the base prompt selection region 350 of the user interface 300.

At block 406, the system 100 transmits a second prompt from the user to the language model via an electronic communication interface. In some aspects, a means for transmitting the second prompt may include the interface 110, the processor 130 executing instructions stored in the memory 135, the bus 170, or the language models 140 of the system 100, or the prompt entry region 310 of the user interface 300.

At block 408, the system 100 receives a second response to the second prompt from the language model via the electronic communication interface. In some aspects, a means for receiving the second response may include the interface 110, the processor 130 executing instructions stored in the memory 135, the bus 170, the language models 140, or the prompt comparison engine 150 of the system 100.

At block 410, the system 100 compares the first prompt to the second prompt. A means for comparing the first prompt to the second prompt may include the processor 130 executing instructions stored in the memory 135, the database 120, or the prompt comparison engine 150 of the system 100.

At block 412 the system 100 compares the first response to the second response. A means for comparing the first response to the second response may include the processor 130 executing instructions stored in the memory 135, the database 120, or the prompt comparison engine 150 of the system 100.

At block 414 the system 100 provides, on a display coupled to the computing device, a first prompt change record representing changes between the first prompt and the second prompt. In some aspects, a means for providing the first prompt change record may include the interface 110, the processor 130 executing instructions stored in the memory 135, the database 120, the bus 170, or the prompt comparison engine 150 of the system 100, or the prompt change region 320 of the user interface 300.

At block 416, the system 100 provides, on the display, a first response change record representing changes between the first response and the second response. In some aspects, a means for providing the first response change record may include the interface 110, the processor 130 executing instructions stored in the memory 135, the database 120, the bus 170, or the prompt comparison engine 150 of the system 100, or the response region 330 of the user interface 300.

In some aspects, the first prompt change record provided in block 414 displays additions to the second prompt not present in the first prompt, and displays portions of the first prompt which are not present in the in the second prompt. In some aspects, the additions to the second prompt not present in the first prompt are depicted underlined, and the portions of the first prompt not present in the second prompt are depicted struck through. In some aspects, the additions to the second prompt are depicted in a first color, and the portions of the first prompt not present in the second prompt are depicted in a second color different from the first color.

In some aspects, the operation 400 further includes, after receiving the second response, transmitting a third prompt to the language model via the electronic communication interface, receiving a third response to the third prompt from the language model via the electronic communication interface, comparing the third prompt to the second prompt, comparing the third response to the second response, providing, on the display, a second prompt change record representing changes between the second prompt and the third prompt, and providing, on the display, a second response change record representing changes between the second response and the third response.

In some aspects, the operation 400 further includes receiving a request from the user to save the second prompt and the second response for comparison with subsequently received prompts and subsequently generated responses, and in response to receiving the request, storing the second prompt and the second response in a memory coupled to the computing device.

In some aspects, transmitting the second prompt in block 406 includes indicating one or more first contexts associated with the second prompt, wherein the second response is generated based at least in part on the one or more first contexts. In some aspects the one or more first contexts indicate at least a region associated with the second prompt. In some aspects the one or more first contexts indicate at least a voice or a tone desired for the second response.

In some aspects, obtaining the first prompt in block 402 includes receiving the first prompt from the user, and obtaining the first response in block 404 includes transmitting the first prompt to the language model via the electronic communication interface and receiving the first response via the electronic communication interface.

In some aspects, obtaining the first prompt in block 402 includes receiving a selection of the first prompt from the user via an interface presented on the display, and retrieving the first prompt from a memory coupled to the computing device, and obtaining the first response in block 404 includes retrieving the first response from the memory. In some aspects, the interface presented on the display comprises a plurality of selectable prompts, wherein each selectable prompt of the plurality of selectable prompts includes a previously submitted prompt associated with a corresponding response previously generated by the language model.

In some aspects, the operation 400 further includes, before transmitting the second prompt, providing the first prompt and the first response on the display.

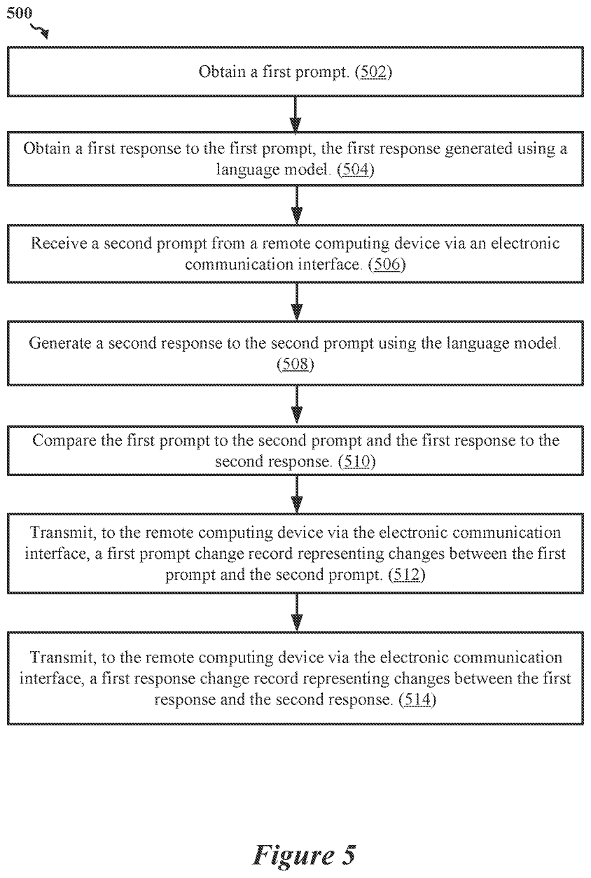

FIG. 5 shows an illustrative flow chart depicting an example operation 500 for the design and iteration of prompts submitted to a text-to-text language model (language model), according to some implementations. The example operation 500 is described as being performed by the system 100 depicted in FIG. 1 with reference to the user interface 300 in FIG. 3 for clarity only, and the operation 500 may be performed by any suitable device or system including or coupled to at least one language model.

At block 502 the system 100 obtains a first prompt. In some aspects, a means for receiving the first prompt may include the interface 110, the processor 130 executing instructions stored in the memory 135, the database 120, the bus 170, or the prompt comparison engine 150 of the system 100, or the base prompt selection region 350 or prompt entry region 310 of the user interface 300.

At block 504, the system 100 obtains a first response to the first prompt, the first response generated using a language model. In some aspects, a means for obtaining the first response may include the interface 110, the processor 130 executing instructions stored in the memory 135, the database 120, the bus 170, the language models 140, or the prompt comparison engine 150 of the system 100, or the base prompt selection region 350 of the user interface 300.

At block 506, the system 100 receives a second prompt from a remote computing device via an electronic communication medium. In some aspects, a means for receiving the second prompt may include the interface 110, the processor 130 executing instructions stored in the memory 135, the bus 170, or the language models 140 of the system 100, or the prompt entry region 310 of the user interface 300.

At block 508, the system 100 generates a second response to the second prompt using the language model. In some aspects, a means for generating the second response may include the interface 110, the processor 130 executing instructions stored in the memory 135, the bus 170, the language models 140, or the prompt comparison engine 150 of the system 100.

At block 510, the system 100 compares the first prompt to the second prompt and the first response to the second response. In some aspects, a means for comparing the first prompt to the second prompt and the first response to the second response may include the processor 130 executing instructions stored in the memory 135, the database 120, or the prompt comparison engine 150 of the system 100.

At block 512, the system 100 transmits, to the remote computing device via the electronic communication medium, a first prompt change record representing changes between the first prompt and the second prompt. In some aspects, a means for transmitting the first prompt change record may include the interface 110, the processor 130 executing instructions stored in the memory 135, the database 120, or the bus 170 or the prompt comparison engine 150 of the system 100.

At block 514, the system 100 transmits, to the remote computing device via the electronic communication medium, a first response change record representing changes between the first response and the second response. In some aspects, a means for transmitting the first response change record may include the interface 110, the processor 130 executing instructions stored in the memory 135, the database 120, the bus 170, or the prompt comparison engine 150 of the system 100.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles, and the novel features disclosed herein.

What is claimed is:

1. A computer-implemented method for the design and iteration of prompts submitted to a text-to-text language model (language model), the method performed by a computing device coupled to the language model and comprising:
obtaining a first prompt from a user;
obtaining a first response to the first prompt, the first response generated by the language model;
transmitting a second prompt from the user to the language model via an electronic communication interface;
receiving, via the electronic communication interface, a second response to the second prompt from the language model;
comparing the first prompt to the second prompt;
comparing the first response to the second response;
providing, on a display coupled to the computing device, a first prompt change record representing changes between the first prompt and the second prompt; and
providing, on the display, a first response change record representing changes between the first response and the second response.

2. The computer-implemented method of claim 1, wherein the first prompt change record displays additions to the second prompt not present in the first prompt, and displays portions of the first prompt which are not present in the second prompt.

3. The computer-implemented method of claim 2, wherein the additions to the second prompt not present in the first prompt are depicted underlined, and wherein the portions of the first prompt which are not present in the second prompt are depicted struck through.

4. The computer-implemented method of claim 2, wherein the additions to the second prompt not present in the first prompt are depicted in a first color, and wherein the portions of the first prompt which are not present in the second prompt are depicted in a second color different from the first color.

5. The computer-implemented method of claim 1, further comprising:
after receiving the second response, transmitting a third prompt to the language model via the electronic communication interface;
receiving a third response to the third prompt from the language model via the electronic communication interface;
comparing the third prompt to the second prompt;
comparing the third response to the second response;
providing, on the display, a second prompt change record representing changes between the second prompt and the third prompt; and
providing, on the display, a second response change record representing changes between the second response and the third response.

6. The computer-implemented of claim 1, further comprising receiving a request from the user to save the second prompt and the second response for comparison with subsequently received prompts and subsequently generated responses, and in response to receiving the request, storing the second prompt and the second response in a memory coupled to the computing device.

7. The computer-implemented of claim 1, wherein transmitting the second prompt comprises indicating one or more first contexts associated with the second prompt, wherein the second response is generated based at least in part on the one or more first contexts.

8. The computer-implemented method of claim 7, wherein the one or more first contexts indicate at least a region associated with the second prompt.

9. The computer-implemented method of claim 7, wherein the one or more first contexts comprise at least a voice or a tone desired for the second response.

10. The computer-implemented method of claim 1, wherein obtaining the first prompt comprises receiving the first prompt from the user, and wherein obtaining the first response comprises transmitting the first prompt to the language model via the electronic communication interface and receiving the first response via the electronic communication interface.

11. The computer-implemented method of claim 1, wherein obtaining the first prompt comprises receiving a selection of the first prompt from the user via an interface presented on the display and retrieving the first prompt from a memory coupled to the computing device, and wherein obtaining the first response comprises retrieving the first response from the memory.

12. The computer-implemented method of claim 11, wherein the interface presented on the display comprises a plurality of selectable prompts, wherein each selectable prompt of the plurality of selectable prompts comprises a previously submitted prompt associated with a corresponding response previously generated by the language model.

13. The computer-implemented method of claim 1, further comprising, before transmitting the second prompt, providing the first prompt and the first response on the display.

14. A system for the design and iteration of prompts submitted to a text-to-text language model (language model), the system comprising:
one or more processors; and
a memory storing instructions that, when executed by the one or more processors, causes the system to perform operations comprising:
obtaining a first prompt from a user;
obtaining a first response to the first prompt, the first response generated by the language model;
transmitting a second prompt from the user to the language model via the electronic communication interface;
receiving, via the electronic communication interface, a second response to the second prompt from the language model;
comparing the first prompt to the second prompt;
comparing the first response to the second response;
providing, on a display coupled to the system, a first prompt change record representing changes between the first prompt and the second prompt; and
providing, on the display, a first response change record representing changes between the first response and the second response.

15. The system of claim 14, wherein the first prompt change record comprises additions to the second prompt not present in the first prompt, and displays portions of the first prompt which are not present in the second prompt.

16. The system of claim 15, wherein the additions to the second prompt not present in the first prompt are depicted underlined, and wherein the portions of the first prompt which are not present in the second prompt are depicted struck through.

17. The system of claim 15, wherein the additions to the second prompt not present in the first prompt are depicted in a first color, and wherein the portions of the first prompt which are not present in the second prompt are depicted in a second color different from the first color.

18. The system of claim 14, wherein execution of the instructions causes the system to perform operations further comprising:
after receiving the second response, transmitting a third prompt to the language model via the electronic communication interface;
receiving a third response to the third prompt from the language model via the electronic communication interface;
comparing the third prompt to the second prompt;
comparing the third response to the second response;
providing, on the display, a second prompt change record representing changes between the second prompt and the third prompt; and
providing, on the display, a second response change record representing changes between the second response and the third response.

19. The system of claim 14, wherein obtaining the first prompt comprises receiving a selection of the first prompt from the user via an interface presented on the display and retrieving the first prompt from a memory coupled to the computing device, and wherein obtaining the first response comprises retrieving the first response from the memory.

20. A computer-implemented method for the design and iteration of prompts submitted to a text-to-text language model (language model), the method performed by a computing device coupled to the language model and comprising:
obtaining a first prompt;
obtaining a first response to the first prompt, the first response generated using the language model;
receiving a second prompt from a remote computing device via an electronic communication interface;
generating a second response to the second prompt using the language model;
comparing the first prompt to the second prompt;
comparing the first response to the second response;
transmitting, to the remote computing device via the electronic communication interface, a first prompt change record representing changes between the first prompt and the second prompt; and
transmitting, to the remote computing device via the electronic communication interface, a first response change record representing changes between the first response and the second response.
